(19) United States
(12) Patent Application Publication
(10) Pub. No.: US 2012/0307881 A1
(43) Pub. Date: Dec. 6, 2012

(54) IMAGE CODING DEVICE, IMAGE CODING/DECODING SYSTEM, IMAGE CODING METHOD, AND IMAGE DISPLAY METHOD

(75) Inventors: Takashi Sawada, Osaka-shi (JP); Takeaki Komuro, Osaka-shi (JP); Toshimitsu Tatsuka, Osaka-shi (JP)

(73) Assignee: MegaChips Corporation, Osaka-shi (JP)

(21) Appl. No.: 13/520,306

(22) PCT Filed: Nov. 9, 2010
(86) PCT No.: PCT/JP10/69939

§ 371 Date: Jul. 2, 2012

(30) Foreign Application Priority Data
Mar. 3, 2010 (JP) 2010-046223

(51) Int. Cl. H04N 11/02

(52) U.S. Cl. 375/240.01; 375/E07.026

(57) ABSTRACT

A device preventing degradation of image quality caused by coding of a moving image. A compression coder performs compression coding on image data of respective pictures constituting an input moving image to generate inter-coded data or intra-coded data, and outputs the coded data to a wire or wireless transmission line. In a case of causing the compression coder to generate the inter-coded data, a controller sets a code amount equal to or smaller than a maximum code amount given by a value obtained by multiplying an upper limit transmission rate of a transmission line and a permissible time allocated per picture based on a picture rate of the input moving image. Meanwhile, in a case of causing the compression coder to generate the intra-coded data, the controller sets a code amount larger than the maximum code amount and equal to or smaller than N-times (N is an integer equal to or larger than two) the maximum code amount.

### TECHNICAL FIELD

The present invention relates to an image coding device, an image coding/decoding system, an image coding method and an image display method.

### BACKGROUND ART

Known as coding methods for moving images are, for example, H.264, moving picture experts group (MPEG)-2 and MPEG-4. Typically, data compression is frequently used in coding, and thus, “coding” and “compression coding” are used for the same meaning at times. In view of the above, they are basically used for the same meaning in the present specification as well.

In the above-mentioned methods, intra coding and inter coding are used in combination. Intra coding is the technique of coding pictures that constitute a moving image only by the pictures independently of other pictures. Therefore, it is possible to decode the picture that has been intra-coded (hereinafter, also referred to as an intra-coded picture) per se. Note that the intra-coded picture is referred to as an intra-picture (I-picture) as well.

Meanwhile, inter coding is the technique of performing inter prediction (also referred to as, for example, inter-screen prediction or inter-picture prediction) using the correlation with another picture to code the prediction results, that is, a predicted picture. Inter prediction is performed with another prediction picture for another picture in some cases. The picture that has been inter-coded (hereinafter, also referred to as an inter-coded picture) cannot be decoded if the picture referred in the inter prediction (referred to as, for example, a reference picture or reference screen as well) is not used. The inter-coded pictures are classified into two types, a predictive picture (P-picture) that is coded based on an earlier picture in a moving image sequence and a bidirectional predictive-picture (B-picture) that is coded based on earlier and later pictures.

In intra coding, at times, a picture to be coded is divided into a plurality of blocks (or macro blocks), and then, intra prediction (also referred to as, for example, intra-screen prediction or intra-picture prediction) is performed using the correlation between blocks.

Patent Document 1 below discloses the technology that appears to relate to the present invention (which is described below).

### PRIOR ART DOCUMENT

### Patent Document

Patent Document 1: Japanese Patent Application Laid-Open No. 2006-287864

### SUMMARY OF THE INVENTION

### Problem to be Solved by the Invention

In a case where a coded picture is transmitted in wire or wireless communication, it is required to control an amount of coded data to be generated (in other words, code amount) so as to fall within the communication band of a transmission line (in other words, transmission rate).

A moving image is composed of successive pictures, and thus, the processing time (in other words, processing delay) that can be spent on each picture to be input successively is limited. Accordingly, a code amount is controlled in accordance with the length of processing time.

However, a small code amount degrades the image quality of a decoded picture. Typically, an intra-coded picture has a larger code amount compared with an inter-coded picture. Therefore, in a case where a code amount is reduced for compliance with various limitations above, a reduction amount is larger in the intra-coded picture than the inter-coded picture.

Accordingly, image quality is more apt to degrade in the intra-coded picture. Further, in a case where a decoded picture corresponding to the intra-coded picture has low image quality, the image quality of the entire moving image decreases in some cases.

Therefore, the present invention has an object to provide the technology capable of preventing the degradation of image quality while complying with various limitations on coding of a moving image. Another object thereof is to provide the technology capable of reducing the processing load of such coding. Still another object thereof is to provide a moving image display technology suitable for the above-mentioned coding technology.

### Means to Solve the Problem

An image coding device according to a first aspect of the present invention includes: compression coding means performing predetermined processes including a generation process of performing compression coding on image data of pictures constituting an input moving image to generate any one of inter-coded data and intra-coded data per picture and an output process of outputting the coded data generated to a wire or wireless transmission line; and control means controlling the compression coding means to generate any one of the inter-coded data and the intra-coded data and controlling a code amount generated by the compression coding, wherein the control means is configured to: set, in a case of causing the compression coding means to generate the inter-coded data, a code amount equal to or smaller than a maximum code amount given by a value obtained by multiplying an upper limit transmission rate of the transmission line and a permissible time allocated per picture based on a picture rate of the input moving image; and set, in a case of causing the compression coding means to generate the intra-coded data, a code amount larger than the maximum code amount and equal to or smaller than N times (N is an integer equal to or larger than two) the maximum code amount.

According to a second aspect, in the image coding device of the first aspect, the compression coding means performs the predetermined processes on the intra-coded data over a processing time longer than the permissible time and equal to or shorter than the N-times the permissible time.

According to a third aspect, in the image coding device of the first or second aspect, the compression coding means does not perform at least the output process of the predetermined processes on {N−1} pictures following the picture corresponding to the intra-coded data.

According to a fourth aspect, in the image coding device of the third aspect, the compression coding means does not perform the generation process of the predetermined processes on the {N−1} pictures.

An image coding device according to a fifth aspect includes: compression coding means performing predetermined processes including a generation process of performing compression coding on image data of pictures constituting an input moving image to generate any one of inter-coded data and intra-coded data per picture and an output process of outputting the coded data generated to a wire or wireless transmission line; and control means controlling the compression coding means to generate any one of the inter-coded data and the intra-coded data and controlling a code amount generated by the compression coding, wherein the compression coding means performs the predetermined processes on the intra-coded data over a processing time longer than a permissible time allocated per picture based on a picture rate of the input moving image and equal to or shorter than N-times (N is an integer equal to or larger than two) the permissible time.

According to a sixth aspect, in the image coding device of the fifth aspect, the compression coding means does not perform the predetermined processes on {N−1} pictures following the picture corresponding to the intra-coded data.

An image coding/decoding system according to a seventh aspect includes: the image coding device according to any one of the first to sixth aspects; and an image decoding device configured to communicate with the image coding device via the wire or wireless transmission line, wherein: the image decoding device includes: decoding means receiving the coded data from the image coding device and performing decoding corresponding to the compression coding based on the coded data to generate decoded data; and output means successively outputting the decoded data successively generated by the decoding to a display device; and the output means repeatedly outputs, to the display device, inter-decoded data corresponding to the inter-coded data received immediately before the intra-coded data until the decoding on the intra-coded data is finished.

An image coding method according to an eighth aspect includes the steps of: (a) performing predetermined processes including a generation process of performing compression coding on image data of pictures constituting an input moving image to generate any one of inter-coded data and intra-coded data per picture and an output process of outputting the coded data generated to a wire or wireless transmission line; and (b) performing, as to the step (a), controlling to generate any one of the inter-coded data and the intra-coded data and controlling a code amount generated by the compression coding, wherein in the step (b): in a case of controlling to generate the inter-coded data in the step (a), a code amount equal to or smaller than a maximum code amount given by a value obtained by multiplying an upper limit transmission rate of the transmission line and a permissible time allocated per picture based on a picture rate of the input moving image is set; and in a case of controlling to generate the intra-coded data in the step (a), a code amount larger than the maximum code amount and equal to or smaller than N-times (N is an integer equal to or larger than two) the maximum code amount is set.

According to a ninth aspect, in the image coding method of the eighth aspect, in the step (a), the predetermined processes on the intra-coded data are performed over a processing time longer than the permissible time and equal to or shorter than the N-times the permissible time.

According to a tenth aspect, in the image coding method of the eight or ninth aspect, in the step (a), at least the output process of the predetermined processes is not performed on {N−1} pictures following the picture corresponding to the intra-coded data.

According to an eleventh aspect, in the image coding method of the tenth aspect, in the step (a), the generation process of the predetermined processes is not performed on the {N−1} pictures.

An image coding method according to a twelfth aspect includes the steps of: (a) performing predetermined processes including a generation process of performing compression coding on image data of pictures constituting an input moving image to generate any one of inter-coded data and intra-coded data per picture and an output process of outputting the coded data generated to a wire or wireless transmission line; and (b) performing, as to the step (a), controlling to generate any one of the inter-coded data and the intra-coded data and controlling a code amount generated by the compression coding, wherein in the step (a), the predetermined processes on the intra-coded data are performed over a processing time longer than a permissible time allocated per picture based on a picture rate of the input moving image and equal to or shorter than the N-times (N is an integer equal to or larger than two) the permissible time.

According to a thirteenth aspect, in the image coding method of the twelfth aspect, in the step (a), the predetermined processes are not performed on {N−1} pictures following the picture corresponding to the intra-coded data.

An image display method according to a fourteenth aspect includes the steps of: receiving the coded data generated by the image coding method according to any one of the eighth to thirteenth aspects via the wire or wireless transmission line; (d) performing decoding corresponding to the compression coding based on the coded data received in said step (c) to generate decoded data; and (e) causing a display device to perform an image display based on the decoded data successively generated in the step (d), wherein in the step (e), the image display is performed by repeatedly using inter-decoded data corresponding to the inter-coded data received immediately before the intra-coded data until the decoding on the intra-coded data is finished.

### Effects of the Invention

According to the first and eighth aspects, the code amount of intra-coded data is set to be larger than the maximum code amount specified based on the transmission rate of a transmission line. For this reason, the image quality of the picture obtained by decoding the intra-coded data can be improved more compared with the case where the code amount of intra-coded data is set to be equal to or smaller than the maximum code amount. Further, this leads to the improvement in image quality of the entire decoded moving image.

According to the second and ninth aspects, the intra-coded data can be generated with a code amount beyond the maximum code amount, and there can be provided a mode in which output of the intra-coded data that has been increased as described above to a transmission line can be finished under the limitations on a transmission rate. According to this one mode, the processing load of the compression coding means can be reduced more compared with the case in which the predetermined processes on the intra-coded data are finished within the permissible time per picture. In addition, it is not less required to employ the high-performance configuration in the compression coding means along with a reduction in processing load, which achieves, for example, cost reduction and power saving.

According to the third and tenth aspects, the {N−1} pictures are thinned out in output to the transmission line, which suppresses the amount of data (code amount) output to the transmission line. In view of the limitations on a transmission rate, the permissible time for the {N−1} pictures is also spent for finishing the output of the increased intra-coded data. Accordingly, in a case where the output of the {N−1} pictures is not thinned out, the data output to the transmission line delays successively, which further leads to the accumulation of delays every time the intra-coded data is output. Meanwhile, according to the third and tenth aspects, it is possible to prevent such an output delay and accumulation of delays.

According to the fourth and eleventh aspects, the processing amount for the {N−1} pictures is reduced. This achieves, for example, power saving.

According to the fifth and twelfth aspects, the code amount of intra-coded data can be increased more than the maximum code amount that can be generated and output within the permissible time per picture. Accordingly, the image quality of a picture obtained by decoding intra-coded data can be improved more compared with the case where only the permissible time is allocated to the intra-coded data. Further, this leads to the improvement in image quality of the entire decoded moving image.

According to the fifth and twelfth aspects, the processing load of the compression coding means can be reduced more compared with the case in which the increased intra-coded data is generated within the permissible time. In addition, it is less required to employ the high-performance configuration in the compression coding means along with a reduction in processing load, which achieves, for example, cost reduction and power saving.

According to the sixth and thirteenth aspects, the {N−1} pictures are thinned out in the output to the transmission line, which suppresses the amount of data (code amount) output to the transmission line. In a case where the output of the {N−1} pictures is not thinned out, the data output to the transmission line delays successively, which further leads to the accumulation of delays every time the intra-coded data is output. Meanwhile, according to the sixth and thirteenth aspects, it is possible to prevent such an output delay and accumulation of delays.

Further, according to the sixth and thirteenth aspects, the processing amount for the {N−1} pictures is reduced. This achieves, for example, power saving.

According to the seventh and fourteenth aspects, longer decoding process time is required for intra-coded data than inter-coded data, where the image obtained by decoding the immediately preceding inter-coded data is repeatedly displayed until the decoding of intra-coded data is finished. This prevents an occurrence of an image loss (for example, interruption of an image entirely displayed in black) in the decoded moving image. An image loss is prevented, and further, display malfunctions due to an image loss (for example, image flicker due to an image loss) are prevented, leading to improvement in image quality of a moving image.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram schematically illustrating an image coding/decoding system according to an embodiment of the present invention.

FIG. 2 is a diagram schematically illustrating the configuration of a moving image.

FIG. 3 is a block diagram schematically illustrating an image coding device according to the embodiment.

FIG. 4 is a block diagram schematically illustrating the image coding device according to the embodiment.

FIG. 5 is a block diagram schematically illustrating an image decoding device according to the embodiment (double buffer configuration).

FIG. 6 is a diagram schematically illustrating the management of a storage area in the double buffer configuration of the image decoding device according to the embodiment.

FIG. 7 is a diagram schematically illustrating the operation of the image coding/decoding system according to the embodiment.

FIG. 8 is a diagram schematically illustrating conventional compression coding.

FIG. 9 is a diagram schematically illustrating compression coding according to the embodiment.

FIG. 10 is a diagram schematically illustrating the operation of the image coding/decoding system according to the embodiment.

FIG. 11 is a diagram schematically illustrating the operation of the image coding/decoding system according to the embodiment.

FIG. 12 is a block diagram schematically illustrating an image decoding device according to a modification (single buffer configuration).

FIG. 13 is a diagram schematically illustrating the management of a storage area in the single buffer configuration of the image decoding device according to the modification.

FIG. 14 is a block diagram schematically illustrating an image coding device according to another modification.

### EMBODIMENTS FOR CARRYING OUT THE INVENTION

<Image Coding/Decoding System 12>

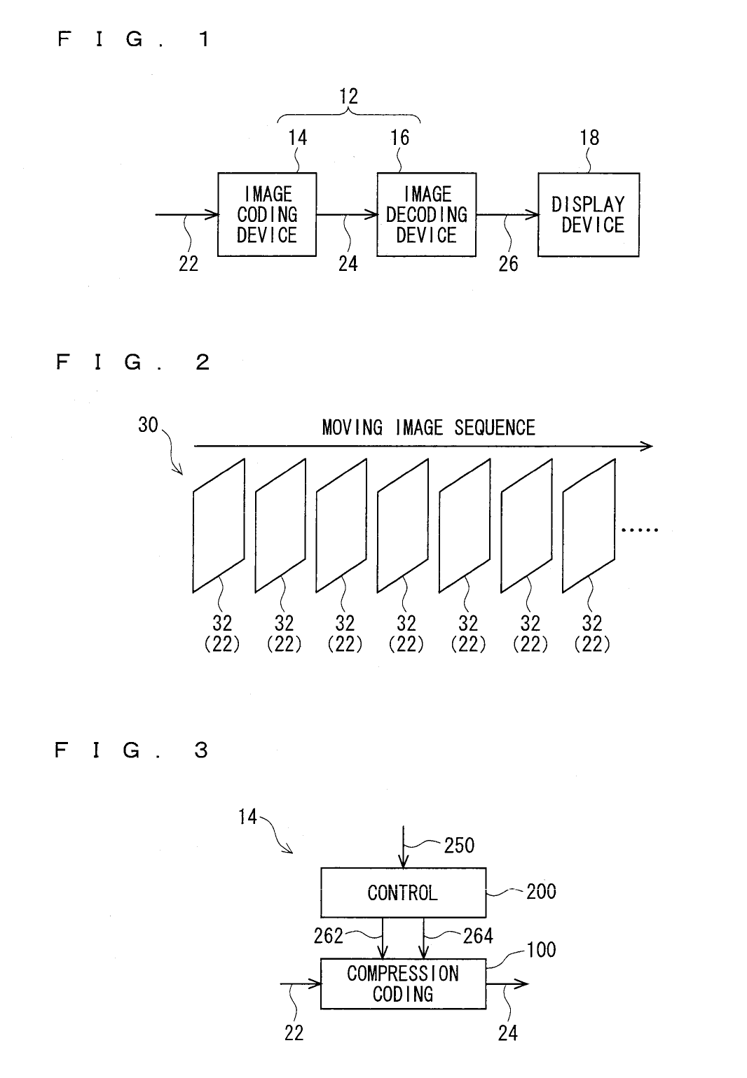

FIG. 1 is a block diagram schematically illustrating an image coding/decoding system 12 according to an embodiment of the present invention. With reference to the example of FIG. 1, the image coding/decoding system 12 includes an image coding device 14 and an image decoding device 16. FIG. 1 shows a display device 18 as well for clarity of description.

Note that the “image coding/decoding system”, “image coding device” and “image decoding device” are abbreviated as “system”, “coding device” and “decoding device”, respectively, in some cases.

The image coding device 14 obtains image data 22 of a moving image as input, codes the image data 22 in accordance with a predetermined coding method to generate coded data 24, and outputs the coded data 24. The input image data 22 (in other words, original image data 22) is supplied from, for example, a moving image supply source (not shown).

The decoding device 16 is configured so as to perform wire or wireless communication with the coding device 14, which obtains the coded data 24 from the coding device 14. The decoding device 16 decodes the coded data 24 that has been obtained in accordance with a predetermined decoding method to generate decoded data 26, and outputs the decoded data 26.

The predetermined decoding method in the decoding device 16 corresponds to the predetermined coding method in the coding device 14. In other words, both methods are in conformity with the same or compatible coding and decoding methods. Examples of the coding and decoding methods include H.264, MPEG-2 and MPEG-4.

The display device 18 is configured so as to perform wire or wireless communication with the decoding device 16, which obtains the decoded data 26 from the decoding device 16. The display device 18 displays a moving image in accordance with the decoded data that has been obtained.

The display device 18 may be housed in the same enclosure as that of the decoding device 16 or may be housed in an enclosure different from that of the decoding device 16.

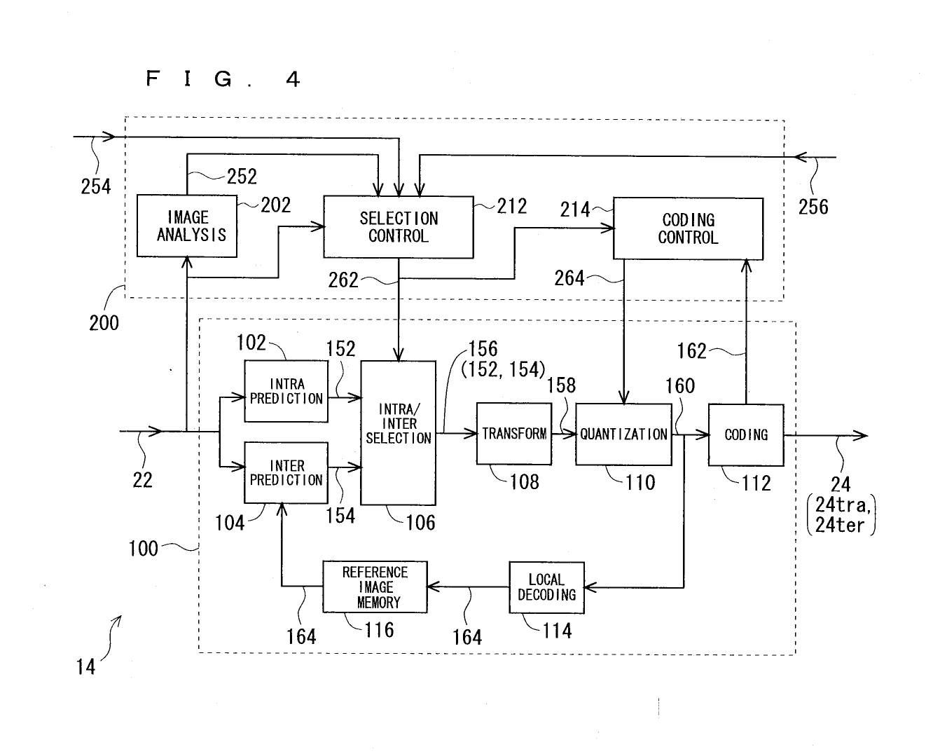

The moving image coded by the coding device 14 is now schematically described with reference to FIG. 2. As schematically shown in FIG. 2, a moving image 30 to be coded is composed of a plurality of pictures (also referred to as picture images) 32 successive in time series. In the example of FIG. 2, the leftmost picture 32 is a leading picture 32, that is, the first picture 32. With such a moving image configuration, the image data of each picture 32 corresponds to the image data 22. Therefore, the image data 22 of each picture 32 is sequentially input to the coding device 14.

Described here as an example is the case where the picture 32 is a frame (also referred to as a frame image) in a non-interlace method (also referred to as progressive method). In this case, the image data 22 is input to the coding device 14 at, for example, a predetermined frame rate, in other words, at time intervals of predetermined length.

It is possible to employ a field (also referred to as a field image) in the interlace method. Alternatively, it is possible to employ a frame composed of two fields as the picture 32 even in the interlace method.

<Image Coding Device 14>

FIG. 3 is a block diagram schematically illustrating the coding device 14. The coding device 14 illustrated in FIG. 3 includes compression coding means 100 and control means 200. Note that the “compression coding means” and “control means” are abbreviated as “compression coding” and “control”, respectively, in FIG. 3. Such notation is used in the drawings below.

The compression coding means 100 obtains the original image data 22 as input per picture and performs compression coding on the original image data 22, to thereby generate the coded data 24 (generation process). Then, the compression coding means 100 outputs the coded data 24 that has been generated to a wire or wireless transmission line (output process). Described here as an example is the case where compression coding is in conformity with H.264. In such an example, any one of the data generated by inter coding (hereinafter, also referred to as inter-coded data) and the data generated by intra coding (hereinafter, also referred to as intra-coded data) is output as the coded data 24 per picture 32.

In this case, the intra-coded data is the data obtained by coding the image data 22 of the picture 32 to be coded, regardless of another picture 32 (see FIG. 2). Therefore, the intra-coded data can be decoded independently. The intra-coded data is also referred to as, for example, intra-coded picture or I-picture.

In intra coding, the picture 32 is divided into a plurality of blocks (or macro blocks) to perform intra prediction using the correlation of blocks at times. Note that the intra-coded data refers to the data coded without depending on another picture regardless of whether or not intra prediction is executed.

The inter-coded data is the data obtained by coding the prediction results of the inter prediction in which the correlation with another picture 32 (or prediction picture thereof) is used. Therefore, the inter-coded data cannot be decoded unless the data of the picture referenced in inter prediction (referred to as, for example, a reference picture or reference screen) is used. The inter-coded data is also referred to as inter-coded picture, and the inter-coded pictures are classified into two types, a P-picture obtained by prediction based on the earlier picture and a B-picture obtained by prediction based on earlier and later pictures.

The control means 200 performs selection control on the compression coding means 100 to output any of the inter-coded data and the intra-coded data. For example, the control means 200 obtains a signal 250 regarding a direction or request for generation of any of the inter-coded data and intra-coded data, generates a control signal 262 corresponding to the contents of the signal 250, and outputs the control signal 262 to the compression coding means 100. As a result, the compression coding means 100 generates and outputs any of the inter-coded data and intra-coded data in accordance with the control signal 262.

Described here as an example is the case where the signal 250 is a signal for requesting the generation of intra-coded data and the control signal 262 is a signal indicating that the compression coding means 100 is caused to generate the intra-coded data. In such an example, the control means 200 obtains the signal 250 for requesting the generation of intra-coded data, to thereby output the signal 262 for directing the generation of intra-coded data to the compression coding means 200. Note that the signals 250 and 262 may be signals including the information for distinguishing whether the generation of any of the intra-coded data and inter-coded data is requested.

While FIG. 3 illustrates the case where the control signal 250 is supplied from the outside of the control means 200, the control signal 250 may be a signal generated in the control means 200 as described below.

The control means 200 controls a code amount generated by compression coding (or code amount generated per unit time (so-called code generation rate)) of the compression coding means 100. For example, the control means 200 obtains the intra-coded data request signal 250 and generates a code amount control signal 264 to output it to the compression coding means 100. Accordingly, the compression coding means 100 sets a code amount in accordance with the control signal 264.

Described here as an example is the case where the code amount is controlled by the control signal 264 in both of the generation of intra-coded data and the generation of inter-coded data.

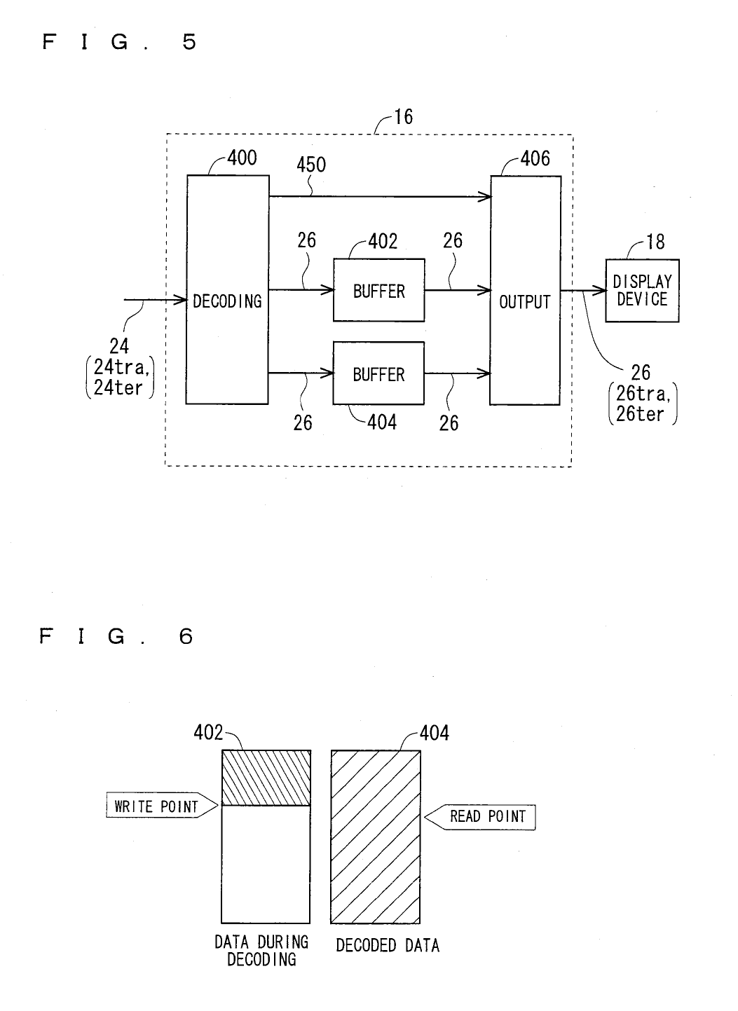

FIG. 4 is a block diagram schematically illustrating a more specific configuration example of the coding device 14. While the H.264-compliant configuration is illustrated here, the coding device 14 is not limited to the configuration example shown.

The compression coding means 100 illustrated in FIG. 4 includes intra prediction means 102, inter prediction means 104, intra/inter selection means 106, transform means 108, quantization means 110, coding means 112, local decoding means 114, and a reference image memory 116. The control means 200 illustrated in FIG. 4 includes image analysis means 202, selection control means 212, and coding control means 214.

The intra prediction means 102 obtains the original image data 22 as input, performs intra prediction on the image data 22 to generate intra prediction data (also referred to as intra prediction picture) 152, and outputs the prediction data 152. Intra prediction is a well-known technique, which is not described here in detail.

The inter prediction means 104 obtains the original image data 22 and data 164 (described below) stored in the reference image memory 116 as input. Then, the inter prediction means 104 performs inter prediction based on those pieces of data 22 and 164 to generate inter prediction data (also referred to as inter prediction picture) 154 regarding the input original image data 22, and outputs the prediction data 154. Inter prediction is a well-known technique, which is not described here in detail.

The intra/inter selection means 106 obtains the intra prediction data 152, the inter prediction data 154, and the control signal 262 output from the selection control means 212 of the control means 200 as input, selects any one of the prediction data 152 and prediction data 154 in accordance with the selection direction by the control signal 262, and outputs the selected prediction data 156.

The transform means 108 obtains the prediction data 156 output from the intra/inter selection means 106 as input, and performs the predetermined transform on the prediction data 156, and outputs transformed data 158. So-called discrete cosine transform (DCT) is described as an example of the predetermined transform. According to the above-mentioned example, the prediction data 156 is orthogonally transformed to a DCT coefficient 158 in a frequency domain.

The quantization means 110 obtains the DCT coefficient 158 and the control signal 264 output from the coding control means 214 of the control means 200 as input. Then, the quantization means 110 quantizes the DCT coefficient 158 in accordance with the contents of the control signal 264 to transform the DCT coefficient 158 into a quantization coefficient 160, and outputs the obtained quantization coefficient 160. The above-mentioned quantization is performed by, for example, dividing the DCT coefficient 158 in a quantization step and rounding the division result to an integer value. The quantization is described further in the description of the coding control means 214.

The coding means 112 obtains the quantization coefficient 160 as input, and performs the predetermined coding on the coefficient 160 to generate the coded data 24, and outputs the data 24. As the predetermined coding, for example, variable-length coding such as Huffman coding and arithmetic coding may be employed. The coded data 24 may be output after the coding of the entire one picture is finished or may be sequentially performed in a partial manner (for example, in units of slices) for one picture.

Here, as to the coded data 24, a reference symbol “24tra” is used for the intra-coded data and a reference symbol “24tra” is used for the inter-coded data as required.

The coding means 112 appropriately outputs information 162 of an amount of data (in other words, amount of generated codes) of the coded data 24 that has been generated to the coding control means 214.

The local decoding means 114 obtains the quantization coefficient 160 output from the quantization means 110 as input. Then, the local decoding means 114 sequentially performs, on the quantization coefficient 160, the process opposite to the quantization by the quantization means 110 (referred to as inverse quantization) and the process opposite to the discrete cosine transform by the transform means 108 (referred to as, for example, inverse discrete cosine transform or inverse DCT). As a result, the prediction data 164 that has been reconfigured is generated and is output from the local decoding means 114. Note that the local decoding means 114 may perform, for example, intra compensation or motion compensation on the operation results by inverse DCT.

The reference image memory 116 is the means for storing the reconfigured prediction data 164 output from the local decoding means 114. The prediction data 164 stored in the memory 116 is used as a reference image when the inter prediction means 104 performs inter prediction.

The image analysis means 202 obtains the original image data 22 as input, detects a scene change (that is, shift of scene) in the moving image 30 (see FIG. 2) based on the data 22, and outputs a signal 252 of the detection results thereof.

The scene change can be detected by comparison between two pieces of image data 22 of two successive pictures 32. More specifically, it is possible to judge that a scene change has occurred in a case where, for example, a difference of the two pieces of image data 22, an average value thereof or the like is larger than a predetermined threshold. On the contrary, it is possible to judge that a scene change has not occurred in a case where, for example, the difference is equal to or smaller than the threshold.

In a case where a scene change has occurred, the picture 32 immediately after the scene change (see FIG. 2) needs to be coded as intra-coded data 24tra. In view of the above, the scene change detection signal 252 is one example of the signal 250 (see FIG. 3) for requesting the compression coding means 110 to generate the intra-coded data 24tra. Unlike as shown in FIG. 3, the request signal 250 may be generated within the control means 200, which has been described above.

Given as an example in which the intra-coded data request signal 250 is input from the outside of the control means 200 is a case where, for example, a moving image supply source (not shown) supplies the control means 200 with a signal 254 for notifying a scene change, together with the original image data 22. For example, the moving image supply source can be configured to output the information as to whether or not the picture 32 is positioned at a scene change as the notification signal 254 together with the image information of the picture 32. Alternatively, if the moving image supply source includes similar means to the image analysis means 202, it can send the scene change notification signal 254.

FIG. 4 illustrates the case where the control means 200 obtains both of the signals 252 and 254 that are specific examples of the intra-coded data request signal 250 (see FIG. 3). Meanwhile, there may be employed a configuration in which any one of the signals 252 and 254 is obtained.

The generation of intra-coded data 24tra is requested for error recovery also in the case where a communication error has occurred between the coding device 14 and the decoding device 16 (see FIG. 1). In this case, a request signal 256 transmitted from the decoding device 16 is equivalent to an example of the intra-coded data request signal 250 supplied from the outside of the control means 200.

In the example of FIG. 4, the intra-coded data request signals 252, 254, and 256 are input to the selection control means 212.

The selection control means 212 may be configured using, for example, a register. Specifically, for example, the state “0” of the register is caused to correspond to the case where the generation of intra-coded data 24tra is requested, and the state “1” of the register is caused to correspond to the case where the generation of inter-coded data 24ter is requested. In this case, upon input of at least one of the intra-coded data request signals 252, 254, and 256, the register is set to “0”. After that, the input of the image data 22 to be subjected to intra coding is checked, and then, the register is set to “1”. The selection control means 212 may output the control signal 262 indicating that intra-coded data is generated, in accordance with the state of the register.

Incidentally, the first picture 32 of the moving image 30 also needs to be transformed to intra-coded data 24tra. It is possible to detect the first picture 32 by detecting, for example, power-on of the coding device 14. For example, if the register is configured to be reset to “0” upon power-on of the coding device 14, it is possible to request intra coding for the image data 22 input first after power-on. The register is set to “1” after the input of the image data 22 of the first picture 32 is checked. In this case, the power supplied upon power-on is an example of the intra-coded data request signal 250 generated within the control means 200.

One register may be shared by the intra-coded data request signals 250 in various modes, or a register may be provided for each of the various modes.

The intra coding indication signal 262 output from the selection control means 212 is input to the intra/inter selection means 106 and the coding control means 214.

The intra/inter selection means 106 outputs the intra prediction data 152 in the case where the intra coding indication signal 262 is received, and outputs the inter prediction data 152 in the case where the intra coding indication signal 262 is not received.

In the case where the intra coding indication signal 262 is received, the coding control means 214 outputs the control signal 264 regarding the generation of intra-coded data 24tra to the quantization means 110. On the other hand, in the case where the intra coding indication signal 262 is not received, the coding control means 214 outputs the control signal 264 regarding the generation of inter-coded data 24ter to the quantization means 110.

In this case, the control signal 264 includes the information of a quantization parameter having the predefined relationship with the quantization step used in the quantization means 210. Accordingly, the quantization means 110 derives the quantization step in accordance with the predefined relationship from the quantization parameter included in the control signal 264 and performs quantization using the obtained quantization step.

In view of the above, the coding control means 214 can control the quantization step by means of the quantization parameter included in the control signal 264. Note that in the configuration example of FIG. 4, the coding control means 214 obtains the information 162 of the past amount of generated codes from the coding means 112, and thus can set the quantization parameter, that is, quantization step with reference to the past amount of generated codes. It is also possible to set a quantization parameter, that is, quantization step irrespective of the past amount of generated codes.

As to the predefined relationship, for example, the quantization parameter is proportional to the quantization step in MPEG-2, and for example, the quantization parameter is proportional to the logarithm of the quantization step in H.264. Generally speaking, the quantization step increases along with an increase of a quantization parameter.

The quantization step is an indicator or index value indicating the roughness (in other words, fineness) of quantization. Therefore, while the degradation of image quality can be suppressed with a smaller quantization step, that is, a smaller quantization parameter, the code amount (that is, amount of data) generated in the coding means 112 increases. That is, the compression ratio decreases as the quantization step and the quantization parameter become smaller.

In view of the above, the coding control means 214 may control the code amount generated by the compression coding means 100 by means of the control signal 264, more specifically, by the quantization parameter included in the control signal 264. A specific example of code-amount control is described below.

<Image Decoding Device 16>

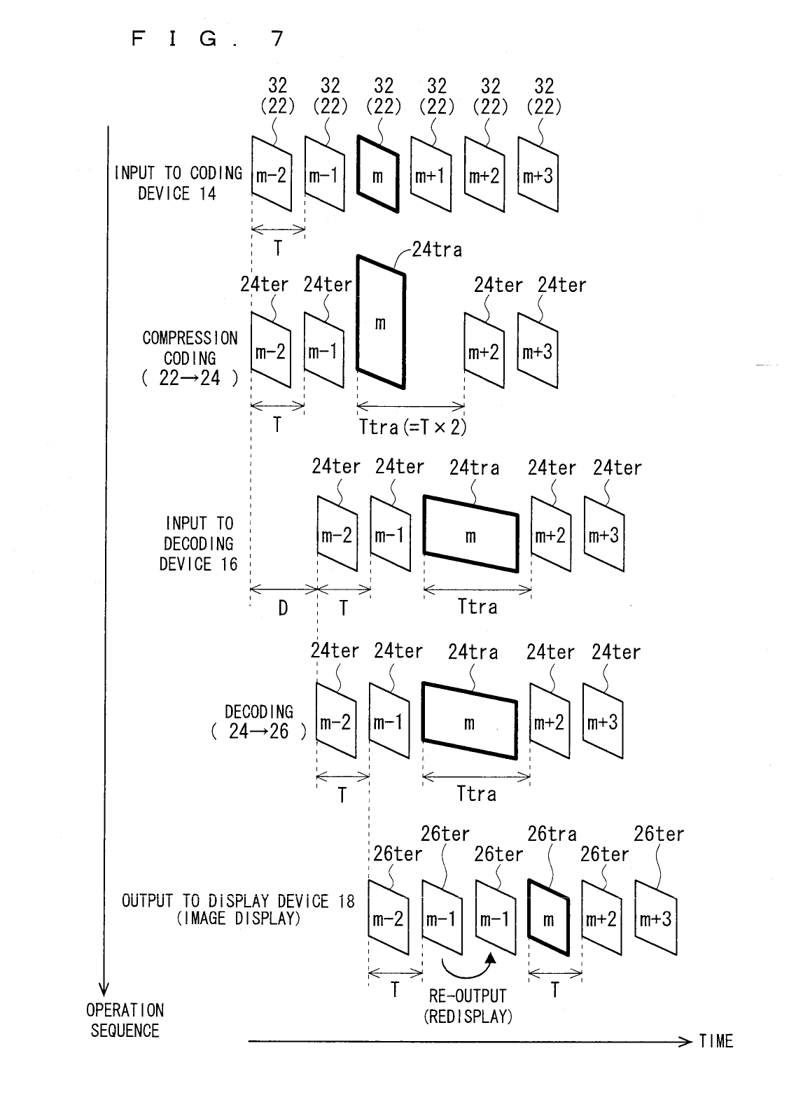

FIG. 5 is a block diagram schematically illustrating the decoding device 16. Note that FIG. 5 shows the display device 18 as well. The decoding device 16 illustrated in FIG. 5 includes decoding means 400, buffers 402 and 404, and output means 406 for a display device.

The decoding means 400 obtains the coded data 24 sent from the coding device 14 (see FIG. 1) as input. Then, the decoding means 400 decodes the coded data 24 that has been obtained in accordance with the decoding method corresponding to the coding method in the compression coding means 100 (see FIG. 4) to generate the decoded data 26, and outputs the decoded data 26.

Here, the decoded data 26 obtained by decoding the intra-coded data 24tra is referred to as intra-decoded data 26tra, and the decoded data 26 obtained by decoding the inter-coded data 24ter is referred to as inter-decoded data 26ter.

The decoding means 400 outputs the decoded data 26 that has been generated (intra-decoded data 26tra or inter-decoded data 26ter) to any one of the two buffers 402 and 404. On this occasion, the decoding means 400 alternately uses the buffers 402 and 404 as buffers for storage. For example, the buffer 402 is used for the data 26 decoded at an odd-numbered time, while the buffer 404 is used for the data 26 decoded at an even-numbered time. According to the above-mentioned double buffer configuration, it is possible to easily prevent overwriting and loss of the data 26 that has not been read out by the output means 406 (see a schematic diagram of FIG. 6).

The decoding means 400 outputs a notification signal 450 indicating decoding of the intra-coded data 24tra to the output means 406, along with decoding. The information indicating the distinction as to whether the data 24 is the intra-coded data 24tra or inter-coded data 24ter is added to the coded data 24, which enables the decoding means 400 to distinguish therebetween.

The notification signal 450 may employ, for example, a mode in which a signal is continued while the intra-coded data 24tra is decoded or may employ a mode in which a signal is transmitted when decoding is started and ended.

The output means 406 is an interface connecting the decoding device 16 and the display device 18. Basically, the output means 406 alternately selects the buffers 404 and 406 to read out the decoded data 26 (intra-decoded data 26tra or inter-decoded data 26ter) that has been stored from the selected buffer.

The output means 406 repeatedly reads out the decoded data 26 from the buffer opposite to the buffer in which the intra-decoded data 26tra is being stored, until the end of decoding of the intra-coded data 24tra. In this case, the inter-decoded data 26, which corresponds to the inter-coded data 24ter received immediately before the intra-coded data 24tra during decoding, is repeatedly read out. The output means 406 is capable of distinguish whether or not the intra-coded data 24tra is being decoded by the notification signal 450.

The output means 406 sequentially outputs the pieces of decoded data 26 read out from the buffers 402 and 404 to the display device 18.

<Operation of System 12>

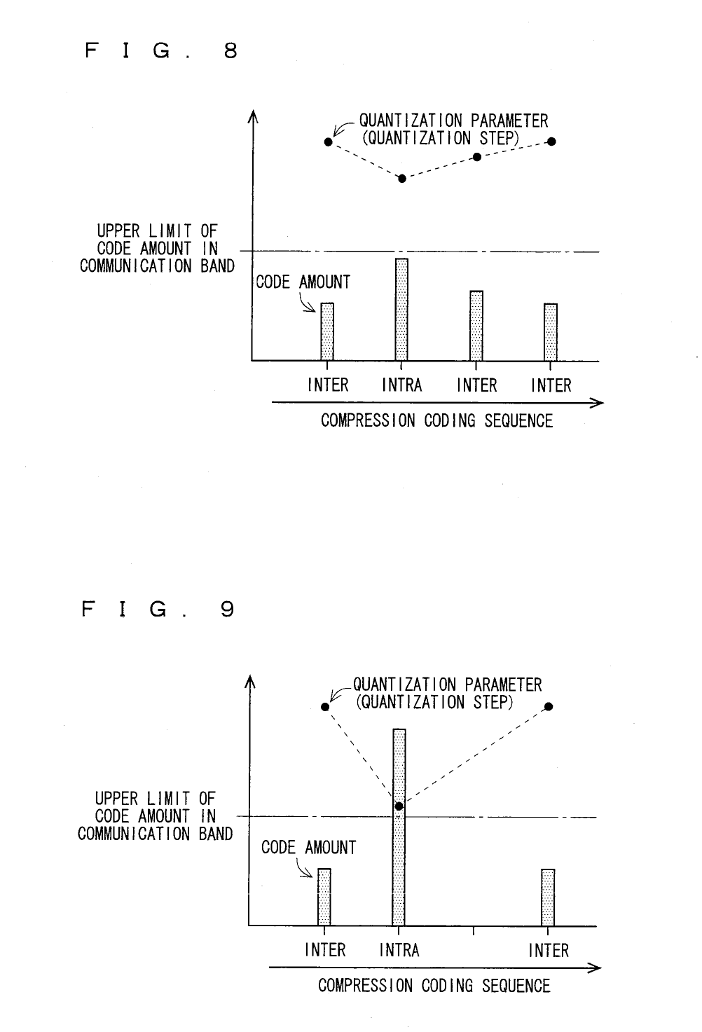

FIG. 7 is a schematic diagram schematically illustrating the operation of the system 12. FIG. 7 shows a flow of operation sequence from top to bottom and an elapse of time from left to right. For clarity of description, FIG. 7 schematically shows the original pictures 32 to be processed and various data corresponding thereto in graphic forms in which tetragons are viewed obliquely. However, such shapes do not show the shapes of images. The amount of data of the picture 32 or the like is schematically indicated by an area of the tetragon. The approximately equal area among the original data 22, coded data 24 and decoded data 26 does not necessarily mean that the amount of data is the same thereamong. The horizontal dimension of the tetragon schematically represents the length of various time periods regarding the picture 32 or the like.

Further, FIG. 7 illustrates the processing situation of the {m−2}th to {m+3}th input pictures 32, and the numbers are placed within the tetragons in order. That is, the symbols in the tetragons are not images. In such illustration, description is given of the case in which intra coding or the like is performed on the m-th picture 32 (in the figure, indicated by a thick line for easy understanding) and inter coding or the like is performed on the other pictures 32. In this case, m represents an integer equal to or larger than four, and the {m−2}th picture 32 is not the first (that is, leading) picture 32. The case where the m-th picture 32 is the first picture can be easily understood from the description below.

<Input of Image Data 22 to Coding Device 14>

As illustrated at the uppermost stage of FIG. 7, the pieces of image data 22 of the {m−2}th to {m+3}th pictures 32 are input to the coding device 14 in this order once every predetermined time T. That is, the image data 22 of the {m−2}th picture 32 is input within the first time T in the range shown in FIG. 7, and the image data 22) of the {m−1}th picture 32 is input within the subsequent time T, and thereafter, the image data 22 is sequentially input in a similar manner.

The predetermined time T is a time period allocated to one picture 32 in advance, which corresponds to one frame period in this case. For example, in a case of a frame rate of 30 frames/second, the length of the time T is 1/30 seconds.

<Compression Coding>

The coding device 14 performs compression coding on each input image data 22 to generate the coded data 24, as described above. FIG. 7 illustrates the case where compression coding is started without delay after the input of the image data 22, not limited to the above-mentioned example.

Pieces of image data 22 are sequentially input at intervals of the time T, and thus, the time period per picture, which is permitted for the processes (including the generation and output of the coded data 24) by the compression coding means 100, is basically the time T.

In particular, in the coding device 14, the coding control means 214 (see FIG. 4) controls the code amount below.

That is, in the case where the compression coding means 100 is caused to generate the inter-coded data 24ter, the coding control means 214 sets a code amount equal to or smaller than the maximum code amount that is determined in accordance with the transmission rate of a wire or wireless transmission line for sending the coded data 24 to the decoding device 16 (more specifically, the maximum code amount is calculated by a value obtained by multiplying an upper-limit transmission rate of a transmission line by the permissible time T). On the other hand, in the case where the compression coding means 100 is caused to generate the intra-coded data 24tra, the coding control means 214 sets a code amount that is larger than the maximum code amount and is equal to or smaller than the N-times (N represents an integer equal to or larger than two) the maximum code amount. In this case, the value of N is set in advance.

The illustration at the second stage of FIG. 7 shows a difference in code amount (amount of data) between the inter-coded data 24ter and the intra-coded data 24tra by a difference in area of the tetragons representing those pieces of data 24ter and 24tra. All pieces of inter-coded data 24ter are shown with the same area, which are merely shown in a simplified manner for the sake of brevity. In the illustration at the second stage of FIG. 7, the horizontal dimension of the tetragon indicating the coded data 24 schematically shows the generation time for the coded data 24.

According to the code amount control described above, it is possible to finish outputting the inter-coded data 24ter within the permissible time T per picture. Meanwhile, it is not possible to finish outputting the intra-coded data 24tra having an amount increased from the maximum code amount within the permissible time T due to the limitations on the transmission rate. Accordingly, a processing time Ttra that is N-times the permissible time T is allocated in the generation and output of the intra-coded data 24tra. FIG. 7 illustrates the case where N=2, that is, Ttra=T×2.

Illustrated at the second stage of FIG. 7 is that though the generation of the intra-coded data 24tra per se can be finished within the permissible time T, the output of the coded data 24tra that has been generated is limited by the transmission rate, and accordingly, the {T×2} processing time is required for the entire process of the intra-coded data 24tra.

In the case of this example, the image data 22 of the next {m+1}th picture 32 is supplied to the compression coding means 100 while the intra-coded data 24tra corresponding to the m-th picture 32 is being output to the transmission line. However, the compression coding means 100 does not generate and output the coded data 24 for the {m+1}th input image data 22, and restarts the generation and output of the coded data 24 from the subsequent {m+2}th input image data 22. That is, the {m+1}th input image data 22 is thinned out in the generation and output of the coded data 24.

In the case where N=3, the {m+1}th and {m+2}th pictures 32 are thinned out.

That is, the generation and output of the coded data 24 are not performed on {N−1} pictures 32 following the picture 32 corresponding to the intra-coded data 24tra, and are restarted from the picture 32 following the {N−1} pictures 32.

Non-execution of the process on the subsequent image data 22 is enabled by, for example, obtaining the value of N in advance, counting the number {N−1} for thinning-out, and outputting none of the intra prediction data 152 and inter prediction data 154 during counting by the intra/inter selection means 106.

Alternatively, for example, the coding means 112 may limit an output and remove the limitation of the intra/inter selection means 106.

Still alternatively, for example, the coding means 112, the control means 200 or the like may limit the input of data to the coding means 112 or the compression coding means 100 and remove the limitation thereof.

<Input of Coded Data 24 to Decoding Device 16>

The pieces of coded data 24 successively transmitted from the coding device 14 are successively received by the decoding device 16. As shown at the third stage of FIG. 7, the coded data 24 received by the decoding device 16 does not include the inter-coded data 24ter corresponding to the {m+1}th picture 32 thinned out by the coding device 14.

In the illustration at the third stage of FIG. 7, the area of the tetragon representing the coded data 24 schematically shows the code amount (amount of data) similarly to the second stage. In addition, in the illustration at the third stage of FIG. 7, the horizontal dimension of the tetragon representing the coded data 24 schematically shows the reception time of the coded data 24.

According to the control of code amount by the coding device 14 and the transmission rate between the devices 14 and 16, as illustrated at the third stage of FIG. 7, the reception of the pieces of coded data 24ter and 24tra can be finished within the predetermined times T and Ttra, respectively. In particular, the reception of the increased intra-coded data 24tra is limited by the transmission rate of a transmission line, which requires the time Ttra longer than the permissible time T.

FIG. 7 illustrates a delay time D from the start of compression coding (here, from input of the image data 22 to the coding device 14) to the arrival of the coded data 24 at the decoding device 16. The above-mentioned delay time D includes the processing time spent in the generation and output of the coded data 24 and the transmission time spent in the transmission between the devices 14 and 16.

<Decoding>

The decoding device 16 decodes the coded data 24 that has been input to generate the decoded data 26 as described above. FIG. 7 illustrates the case where decoding is started without delay after the input of the coded data 24, not limited to this example.

In the illustration at the fourth stage of FIG. 7, the area of the tetragon representing the coded data 24 schematically shows the code amount (amount of data) similarly to the second stage and the third stage. In addition, in the illustration at the fourth stage of FIG. 7, the horizontal dimension of the tetragon representing the coded data 24 schematically shows the processing time required for decoding the coded data 24.

As illustrated at the fourth stage of FIG. 7, decoding of the pieces of coded data 24ter and 24tra can be finished within the predetermined times T and Ttra, respectively. In particular, a longer time period than the permissible time T is spent in the reception of the increased intra-coded data 24tra per se, and accordingly, a time period longer than the permissible time T is required in decoding as well.

<Output of Decoded Data 26 to Display Device 18>

The decoding device 16 successively outputs the decoded data 26 to the display device 18 as described above. As a result, images based on the pieces of decoded data 26 are successively displayed on the display device 18, whereby a moving image that has been decoded is obtained. FIG. 7 illustrates the case where there occurs a delay of the same length as the processing time T from the start of decoding to the output of the decoded data 26, not limited to the above-mentioned example.

In this case, the processing time Ttra for decoding the intra-coded data 24tra is longer than the processing time T for decoding the inter-coded data 24ter. This results in a case in which decoding of the intra-decoded data 26ter corresponding to the m-th picture 32 may not be finished after the output of the inter-decoded data 26ter corresponding to the {m−1}th picture 32.

In view of the above, the output means 406 of the decoding device 16 outputs the inter-decoded data 26ter immediately before the intra-decoded data 26tra, that is, decoded data 26ter corresponding to the {m−1}th picture 32 again as shown at the lowermost stage of FIG. 7. As a result, the decoded data 26ter corresponding to the {m−1}th picture 32 is displayed again.

For example, in the case where Ttra=T×3, the decoding device 16 successively outputs the decoded data 26ter corresponding to the {m−1}th picture 32 three times in total.

That is, the inter-decoded data 26ter corresponding to the inter-coded data 24ter that has been received immediately before the intra-coded data 24tra is repeatedly output to the display device 18 until the end of the decoding of the intra-coded data 24tra.

Preferably, the same decoded data 26ter is displayed repeatedly so as not to exceed the time period when a human eye cannot recognize the decoded data 26ter as a static image. This is because, if the same image (pattern) continues beyond the predetermined time period, a human eye is apt to recognize the same image as a static image, leading to the degradation of image quality as a moving image. The predetermined time period is estimated at approximately 0.1 seconds, which varies among individuals. In other words, for example, in the case where the frame rate of an input moving image is 30 frames/second, two or three is preferably selected as the value of N above (N is an integer equal to or larger than two).

According to the coding device 14, decoding device 16, system 12 and various techniques employed therein, effects below are achieved.

First, the code amount of the intra-coded data 24tra is set to be larger than the maximum code amount specified based on the transmission rate of a transmission line. Accordingly, the image quality of a picture obtained by decoding intra-coded data can be improved more compared with the case where the code amount of the intra-coded data 24tra is set to be equal to or smaller than the maximum code amount similarly to the inter-coded data 24ter. This further results in the improvement of the image quality of the entire decoded moving image.

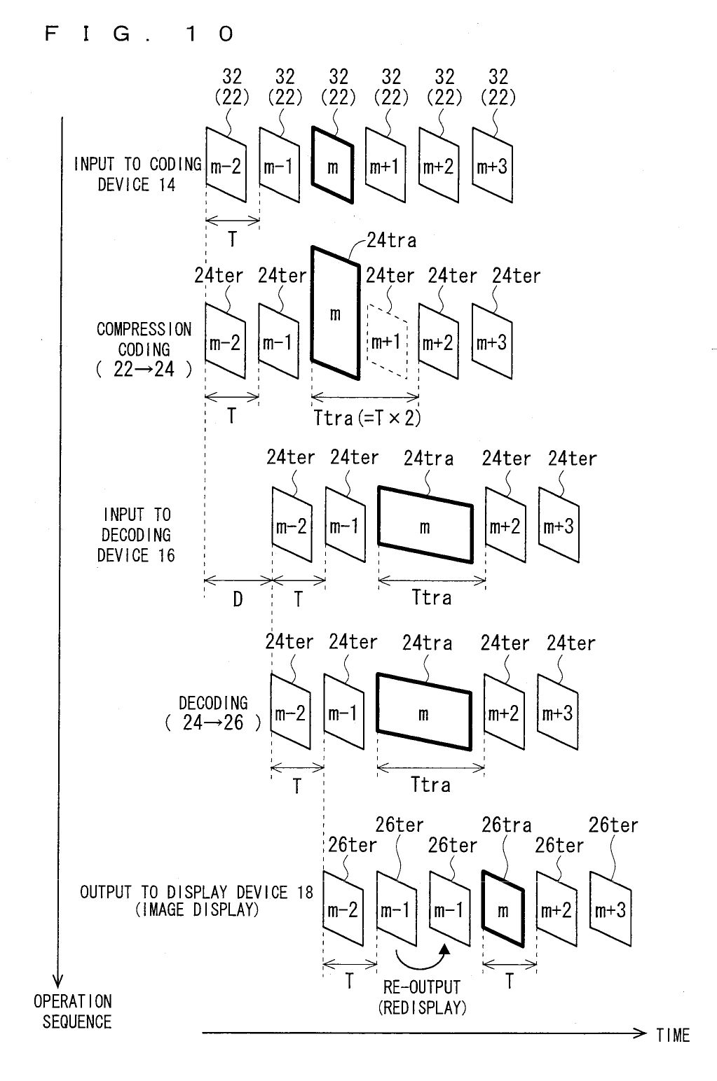

As shown in the schematic diagram of FIG. 8, in conventional compression coding, a quantization parameter is controlled such that a code amount to be generated is equal to or smaller than the maximum code amount determined in accordance with the transmission rate in both of the inter-coded data and intra-coded data.

Meanwhile, according to the coding device 14, as shown in the schematic diagram of FIG. 9, a code amount beyond the maximum code amount is allowed in the intra-coded data. However, the output is limited by a transmission rate, and thus, a longer time period is required for the completion of output to a transmission line compared with the inter-coded data.

FIG. 8 and FIG. 9 illustrate the case where the code amount in inter coding varies. The code amount to be generated normally depends also on a pattern (contents of an image), which makes it extremely difficult to hold a constant code amount. For this reason, illustrated here is an example of the results obtained by coding for achieving image quality as high as possible, that is, a large code amount, below the upper limit of the code amount in a communication band.

Further, as to the {N−1} pictures 32 following the picture 32 corresponding to the intra-coded data 24tra, the generation and output of the coded data 24 are thinned out, which suppresses an amount of data (code amount) output to a transmission line. In view of the limitations on a transmission rate, the permissible time T for the {N−1} pictures 32 is spent for completion of the output of the increased intra-coded data 24tra. Therefore, in a case where the {N−1} pictures 32 are not thinned out, the data output to a transmission line successively delays, resulting in the accumulation of delays every time the intra-coded data 24tra is output. Meanwhile, the above-mentioned thinning-out technique prevents the output delay and accumulation of delays as described above.

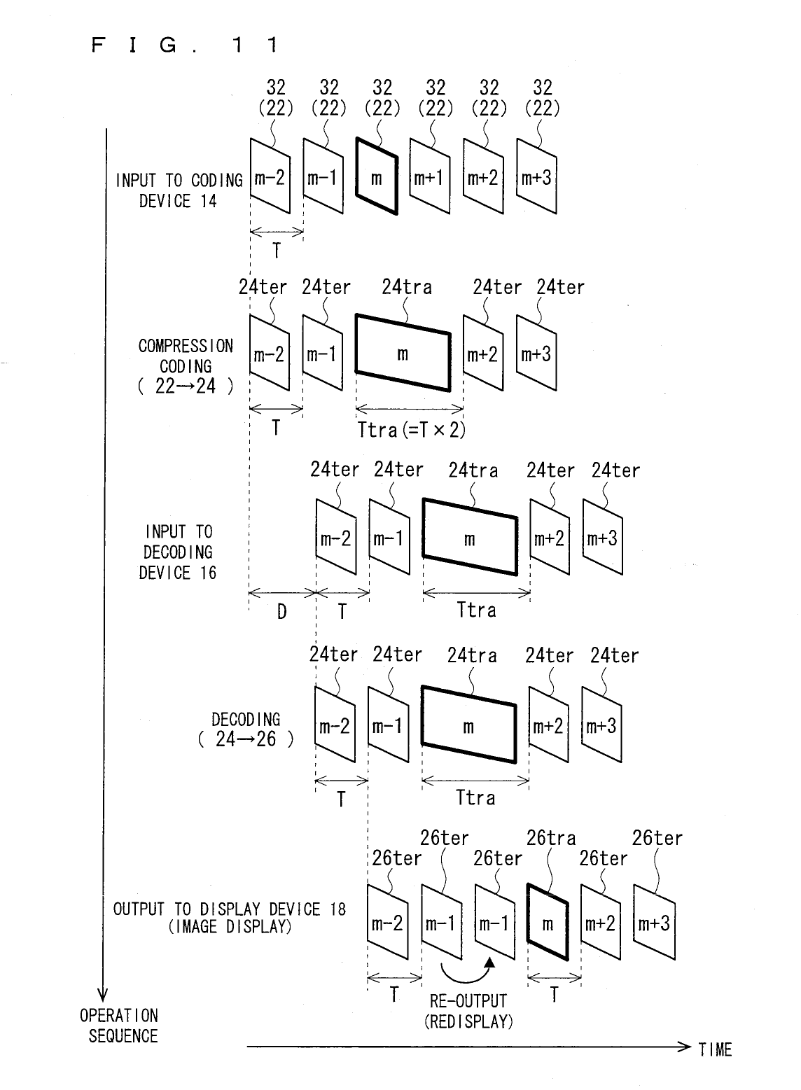

Illustrated at the second stage of FIG. 7 is the mode in which the generation of intra-coded data 24tra per se is finished within the permissible time T as described above. As indicated by a broken line at the second stage of FIG. 10, in such an example, it is possible to perform inter coding on the {m+1}th picture 32 that is thinned out in the description above. However, in the case where the inter-coded data 24ter that has been generated is output, an output delay occurs and delays are accumulated as described above.

Therefore, preferably, even the generation of the coded data 24 that is not planned to be output to a transmission line is not performed for reducing a processing amount, as in the example of FIG. 7. For example, the reduction of processing amount saves power.

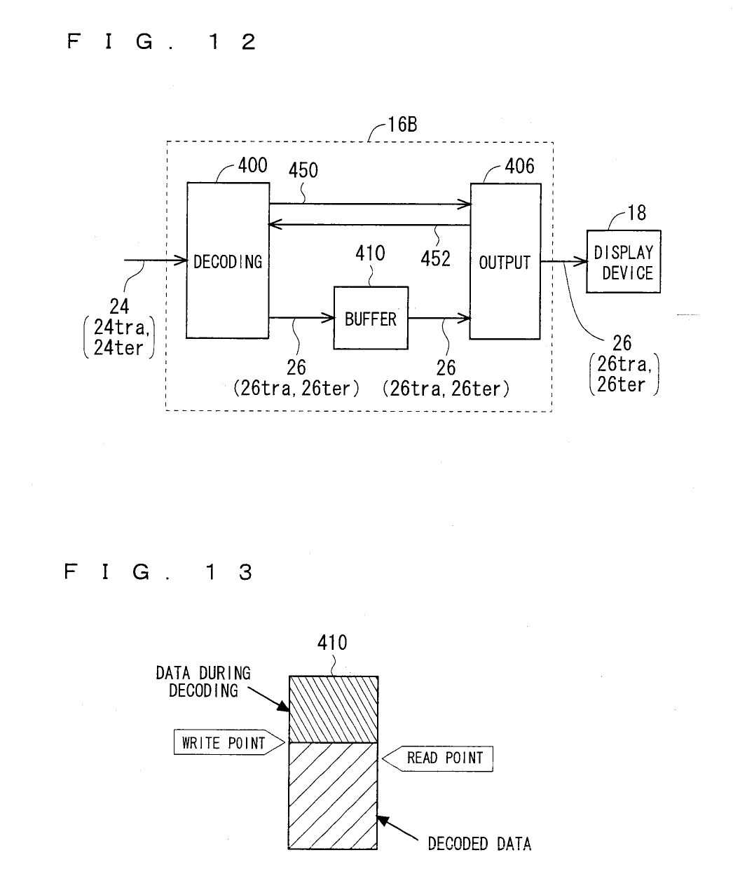

Even in a case where the compression coding means 100 has the performance for finishing the generation of intra-coded data 24tra per se within the permissible time T as described above, if the longer time Ttra is required until the output is finished due to a transmission line, the time period for generating the intra-coded data 24tra may be set longer than the permissible time T (see FIG. 11).

That is, the process regarding the intra-coded data 24tra may be performed entirely in the processing time Ttra that is longer than the permissible time T and is equal to or shorter than the N-times the permissible time T. In such a mode, the intra-coded data 24tra can be generated with a code amount beyond the maximum code amount, and besides, the output of the intra-coded data 24tra increased as described above to a transmission line can be finished while following the limitations on a transmission rate.

As a result, it is possible to reduce the processing load of the compression coding means 100 more compared with the example of FIG. 7. In addition, the high-performance configuration is less required for the compression coding means 100 along with a decrease in processing load, which leads to, for example, a cost reduction and power saving.

The intra-coded data 24tra requires a decoding time period longer than the inter-coded data 24ter in the above, where an image obtained by decoding the immediately preceding inter-coded data 24ter is repeatedly displayed until decoding of the intra-coded data 24tra is finished. This prevents a loss of an image (for example, interruption of an image entirely displayed in black) in the decoded moving image. The image quality of a moving image can be improved by preventing a loss of an image and further preventing malfunctions in display due to the loss of an image (for example, an image flicker due to the loss of an image).

Described above as examples are various modes in which an amount of intra-coded data 24tra may be increased in a case where the transmission rate is limited. The application of the mode of FIG. 11 among them enables to increase an amount of intra-coded data 24tra even in a case where the performance (for example, processing speed) of the compression coding means 100 is limited.

Specifically, the compression coding means 100 may perform predetermined processes (including generation and output to a transmission line) for the intra-coded data 24tra over the processing time that is longer than the permissible time T and is equal to or shorter than N-times the permissible time T.

This enables to increase the code amount of intra-coded data 24tra more than the maximum code amount that can be generated and output within the permissible time T per picture. Accordingly, it is possible to improve the image quality of the picture obtained by decoding the intra-coded data 24tra more compared with the case where only the permissible time T is allocated to the intra-coded data 24tra. This further results in the improvement in image quality of the entire decoded moving image.

Further, a less amount of processing load of the compression coding means 100 is required compared with the case where the increased intra-coded data 24tra is generated within the permissible time T. As a result, it is less required to employ the high-performance configuration in the compression coding means 100 and, for example, a configuration with a slow processing speed can be employed. This results in, for example, lower cost and power saving.

In the coding method described in Patent Document 1 above, an image immediately after a scene change is coded as an I-picture and is set to the head of a new group of picture (GOP). In addition, in this coding method, a picture type (type of I, P or B picture) is determined based on the detection results of a scene change and accumulation data of the past coding results, to thereby control a coding bit rate in accordance with the determined picture type. Further, a technique of rendering a GOP length variable and a technique of fixing the GOP length and distributing the information amount of pictures in the fixed length are introduced in this coding method.

However, Patent Document 1 does not disclose the various techniques employed by the coding device 14 and the like. For example, Patent Document 1 does not disclose the technique of increasing the code amount of intra-coded data 24tra to achieve high image quality while satisfying the constraints caused by the transmission rate of a transmission line and the constraints due to the performance of the compression coding means 100. In addition, for example, Patent Document 1 does not disclose the technique of thinning out the image data 22 input during the execution of intra coding. Further, Patent Document 1 does not disclose the technique of repeatedly outputting the inter-decoded data 26ter immediately before the intra-decoded data 26tra to a display device.

<First Modification>

FIG. 12 is a block diagram schematically illustrating a decoding device 16B in which a single buffer configuration is employed. The decoding device 16B has a configuration in which the two buffers 404 and 406 of the decoding device 16 (see FIG. 5) are replaced by one buffer 410.

In the single buffer configuration, the intra-decoded data 26tra and inter-decoded data 26ter are both stored in the buffer 410. For this reason, the output means 406 directs write permission/inhibition for the decoding means 400 by a signal 452, to thereby prevent the overwriting and loss of the necessary data 26.

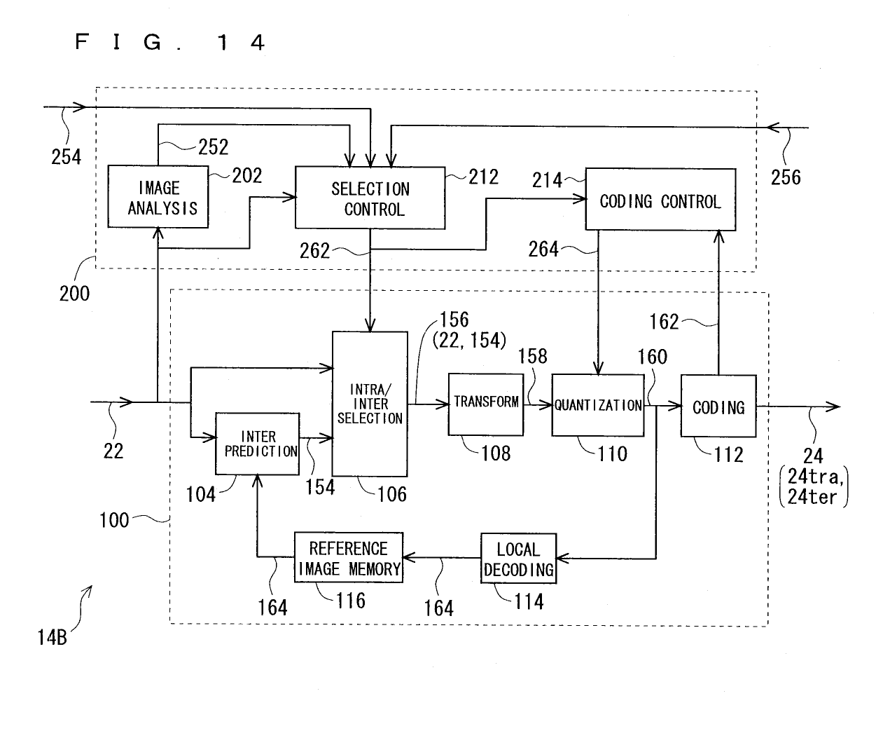

Specifically, no problem occurs if the storage area of the decoded data 26 that has been output (including the repetitive output above) to the display device 18 is overwritten in the buffer 410, and thus, the output means 406 notifies the decoding means 400 of the occurrence of such an overwrite-permitted area or, in addition, the specification of the position of that area, by the write-permitting signal 452. The decoding means 400 performs decoding upon reception of the signal 452, and writes the decoded data 26 to the permitted area (see schematic diagram of FIG. 13).

Note that the write-permitting signal 452 may be sent at a time when a storage area large enough to store the entire decoded data 26 occurs or may be sent at a time when a storage area large enough to store the decoded data 26 partially (for example, in units of blocks) occurs.

The various effects described above are achieved by the decoding device 16B as well.

<Second Modification>

The case where the intra prediction data 152 and the inter prediction data 154 are both generated for the same input image data 22 has been descried above as an example (see FIG. 4). Meanwhile, a modification may be made such that only one of the intra prediction data 152 and the inter prediction data 154 is generated by controlling only any one of the intra prediction means 102 and the inter prediction means 104 by the control means 200 in accordance with reception/non-reception of the intra-coding request signal 250 (see FIG. 3). The various effects described above are achieved also in such a case.

<Third Modification>

As described above, intra coding is the process of coding a target picture 32 without depending on another picture 32. Accordingly, intra coding includes a case in which the input image data 22 is coded as it is without performing intra prediction.

Illustrated as FIG. 14 is a block diagram of a coding device 14B in view of the above. In the coding device 14B, the intra prediction means 102 is removed from the configuration illustrated in FIG. 4, the input image data 22 is input to the intra/inter selection means 106, and the intra/inter selection means 106 outputs any one of the input image data 22 and the inter prediction data 154. The other configuration of the coding device 14B is similar to that of the coding device 14 (see FIG. 4). The various effects described above are achieved also by the coding device 14B.

While the invention has been shown and described in detail, the foregoing description is in all aspects illustrative and not restrictive. It is therefore understood that numerous modifications and variations can be devised without departing from the scope of the invention.

### DESCRIPTION OF REFERENCE SYMBOLS

12 image coding/decoding system
14, 14B image coding device
16, 16B image decoding device
18 display device
22 image data
24 coded data
24ter inter-coded data
24tra intra-coded data
26 decoded data
26ter inter-decoded data
26tra intra-decoded data
30 moving image
32 picture
100 compression coding means
200 control means
400 decoding means
406 output means
T, Ttra processing time

1-14. (canceled)

15. An image coding device, comprising:
a compression coding part performing predetermined processes including a generation process of performing compression coding on image data of pictures constituting an input moving image to generate any one of inter-coded data and intra-coded data per picture and an output process of outputting the coded data generated by said generation process to a wire or wireless transmission line; and
a control part controlling said compression coding part to generate any one of said inter-coded data and said intra-coded data and controlling a code amount generated by said compression coding,
wherein said control part is configured to:
set, in a case of causing said compression coding part to generate said inter-coded data, a code amount equal to or smaller than a maximum code amount given by a value obtained by multiplying an upper limit transmission rate of said transmission line and a permissible time allocated per picture based on a picture rate of said input moving image; and
set, in a case of causing said compression coding part to generate said intra-coded data, a code amount larger than said maximum code amount and equal to or smaller than N-times (N is an integer equal to or larger than two) said maximum code amount.

16. The image coding device according to claim 15, wherein said compression coding part performs said predetermined processes on said intra-coded data over a processing time longer than said permissible time and equal to or shorter than said N-times said permissible time.

17. The image coding device according to claim 15, wherein said compression coding part does not perform at least said output process of said predetermined processes on {N−1} pictures following said picture corresponding to said intra-coded data.

18. The image coding device according to claim 17, wherein said compression coding part does not perform said generation process of said predetermined processes on said {N−1} pictures.

19. An image coding device, comprising:
a compression coding part performing predetermined processes including a generation process of performing compression coding on image data of pictures constituting an input moving image to generate any one of inter-coded data and intra-coded data per picture and an output process of outputting the coded data generated by said generation process to a wire or wireless transmission line; and
a control part controlling said compression coding part to generate any one of said inter-coded data and said intra-coded data and controlling a code amount generated by said compression coding,
wherein said compression coding part performs said predetermined processes on said intra-coded data over a processing time longer than a permissible time allocated per picture based on a picture rate of said input moving image and equal to or shorter than N-times (N is an integer equal to or larger than two) said permissible time.

20. The image coding device according to claim 19, wherein said compression coding part does not perform said predetermined processes on {N−1} pictures following said picture corresponding to said intra-coded data.

21. An image coding/decoding system, comprising:
the image coding device according to claim 15; and
an image decoding device configured to communicate with said image coding device via said wire or wireless transmission line,
wherein said image decoding device includes:
a decoding part receiving said coded data from said image coding device and performing decoding corresponding to said compression coding based on said coded data to generate decoded data; and
an output part successively outputting said decoded data successively generated by said decoding to a display device, and
wherein said output part repeatedly outputs, to the display device, inter-decoded data corresponding to said inter-coded data received immediately before said intra-coded data until said decoding on said intra-coded data is finished.

22. An image coding/decoding system, comprising:
the image coding device according to claim 19; and
an image decoding device configured to communicate with said image coding device via said wire or wireless transmission line,
wherein said image decoding device includes:
a decoding part receiving said coded data from said image coding device and performing decoding corresponding to said compression coding based on said coded data to generate decoded data; and
an output part successively outputting said decoded data successively generated by said decoding to a display device, and
wherein said output part repeatedly outputs, to the display device, inter-decoded data corresponding to said inter-coded data received immediately before said intra-coded data until said decoding on said intra-coded data is finished.

23. An image coding method, comprising:
(a) performing predetermined processes including a generation process of performing compression coding on image data of pictures constituting an input moving image to generate any one of inter-coded data and intra-coded data per picture and an output process of outputting the coded data generated by said generation process to a wire or wireless transmission line; and
(b) performing, as to said step (a), controlling to generate any one of said inter-coded data and said intra-coded data and controlling a code amount generated by said compression coding,
wherein in said step (b):
in a case of controlling to generate said inter-coded data in said step (a), a code amount equal to or smaller than a maximum code amount given by a value obtained by multiplying an upper limit transmission rate of said transmission line and a permissible time allocated per picture based on a picture rate of said input moving image is set; and
in a case of controlling to generate said intra-coded data in said step (a), a code amount larger than said maximum code amount and equal to or smaller than N-times (N is an integer equal to or larger than two) said maximum code amount is set.

24. The image coding method according to claim 23, wherein in said step (a), said predetermined processes on said intra-coded data are performed over a processing time longer than said permissible time and equal to or shorter than said N-times said permissible time.

25. The image coding method according to claim 23, wherein in said step (a), at least said output process of said predetermined processes is not performed on {N−1} pictures following said picture corresponding to said intra-coded data.

26. The image coding method according to claim 25, wherein in said step (a), said generation process of said predetermined processes is not performed on said {N−1} pictures.

27. An image coding method, comprising:
(a) performing predetermined processes including a generation process of performing compression coding on image data of pictures constituting an input moving image to generate any one of inter-coded data and intra-coded data per picture and an output process of outputting the coded data generated by said generation process to a wire or wireless transmission line; and
(b) performing, as to said step (a), controlling to generate any one of said inter-coded data and said intra-coded data and controlling a code amount generated by said compression coding,
wherein in said step (a), said predetermined processes on said intra-coded data are performed over a processing time longer than a permissible time allocated per picture based on a picture rate of said input moving image and equal to or shorter than N-times (N is an integer equal to or larger than two) said permissible time.

28. The image coding method according to claim 27, wherein in said step (a), said predetermined processes are not performed on {N−1} pictures following said picture corresponding to said intra-coded data.

29. An image display method, comprising:
(c) receiving said coded data generated by the image coding method according to claim 23 via said wire or wireless transmission line;
(d) performing decoding corresponding to said compression coding based on said coded data received in said step (c) to generate decoded data; and
(e) causing a display device to perform an image display based on said decoded data successively generated in said step (d),
wherein in said step (e), said image display is performed by repeatedly using inter-decoded data corresponding to said inter-coded data received immediately before said intra-coded data until said decoding on said intra-coded data is finished.

30. An image display method, comprising:
(c) receiving said coded data generated by the image coding method according to claim 27 via said wire or wireless transmission line;
(d) performing decoding corresponding to said compression coding based on said coded data received in said step (c) to generate decoded data; and
(e) causing a display device to perform an image display based on said decoded data successively generated in said step (d),
wherein in said step (e), said image display is performed by repeatedly using inter-decoded data corresponding to said inter-coded data received immediately before said intra-coded data until said decoding on said intra-coded data is finished.
